(19) United States
(12) Patent Application Publication
(10) Pub. No.: US 2004/0045387 A1
(43) Pub. Date: Mar. 11, 2004

(54) Barrel-shaped pinion

(75) Inventors: Jens Keller, Solingen (DE); Paul Hein, Solingen (DE); Dirk Sickert, Bruehl (DE)

Correspondence Address: BRINKS HOFER GILSON & LIONE, P.O. BOX 10395, CHICAGO, IL, 60611, US

(73) Assignee: Visteon Global Technologies, Inc.

(21) Appl. No.: 10/236,593

(22) Filed: Sep. 6, 2002

(51) Int. Cl. F16H 1/04

(52) U.S. Cl. 74/422

(57) ABSTRACT

Barrel-shaped pinions and methods for their engagement with racks are provided allowing for a larger margin of inaccuracy between the rack and pinion gear set avoiding the necessity of costly, high-precision manufacturing processes. The generally barrel-shaped pinion has an outer toothed surface extending axially along a portion of the pinion. The toothed outer surface has first and second ends and a middle section. A diameter of the middle section is larger than a diameter of both the first and second ends. Also provided is a dual-pinion rack gear system utilizing a first driven pinion, a second generally barrel-shaped drive pinion and a rack. Teeth of the first driven pinion and teeth of the second drive pinion mesh with teeth of the rack at two separate locations.

### BACKGROUND OF THE INVENTION

This invention relates generally to a barrel-shaped pinion and method for its engagement with a rack.

Pinion-driven electrical steering gears are frequently used in vehicles. Both single-pinion and dual-pinion electrical steering gears are utilized in combination with a rack. The prior art has utilized cylindrically-shaped pinions for both single and dual-pinion arrangements.

The dual-pinion gear has one pinion that is driven by an electrical motor (“the driven pinion”) and a second pinion that is connected to the steering wheel via a coupling and a column (“the drive pinion”). Both the teeth of the driven pinion and the teeth of the drive pinion are in meshing engagement with the teeth of the rack at different locations along the rack. The driven pinion leads the rack and causes axial movement of the rack. Different package situations sometimes require alignment of each of the dual-pinions at an angle to each other around the circumference of the rack.

The tolerance for this angle is partly dependent upon the tolerances of the teeth at each rack location which are engaged with the respective teeth of each dual-pinion. Additionally, the tolerance for this angle is dependent upon the axial machine tolerances of the pinion tower housings which hold each pinion. If the pinion tower housings are not machined straight, the angle between the pinions changes. When this occurs, the clearance between the teeth of the rack and the teeth of each pinion within an improperly machined pinion tower housing decreases because the pinion's centerline is no longer perpendicular to the rack. Therefore, the clearance varies as the pinion rotates due to the uneven alignment along the rack.

Because of this, the angle of the dual-pinions with respect to each other around the circumference of the rack must be very tight in order to avoid a misaligned pinion/rack gear set. It is important to avoid such misalignment because such can lead to the detrimental effects of pinion torque increase, bad return, worsened peak-to-peak variation and noise vibration harshness problems such as knocking.

The current manufacturing processes for the tooth system on a rack are broaching, grinding and forming. After these processes a heat treatment process is performed to harden the teeth, and also sometimes to harden the rack. The tension/stress during the heat treatment process often generates torsion and bending of the rack. After the heat treatment process the rack undergoes a straightening process to remove the torsion and bending.

On a rack with only one tooth system area the above referenced manufacturing processes are practicable without extraordinary efforts or expenses. However on a rack with two tooth system areas, and in particular on a rack with two tooth system areas at an angle to each other around the circumference of the rack sometimes having different teeth ratios, the manufacturing processes need to be extremely accurate. To maintain this accuracy during manufacturing of the pinions and rack tight tolerance ranges are required. This necessitates the use of high-expense, time-consuming, high-manpower manufacturing processes and high-quality measuring equipment.

A new pinion design is required which allows a larger margin of inaccuracy between the rack and pinion gear set to avoid the necessity of costly, high-precision manufacturing processes.

### BRIEF SUMMARY OF THE INVENTION

It is in general an object of the invention to provide a barrel-shaped pinion and method for its engagement with a rack.

In one aspect this invention provides a pinion comprising a generally barrel-shaped toothed outer-surface extending axially along a portion of the pinion. The toothed outer surface has first and second ends and a middle section. A diameter of the middle section is larger than a diameter of the first end, and larger than a diameter of the second end.

In another aspect this invention provides a dual-pinion rack gear system. The system comprises a first driven pinion driven by an electrical motor, a second drive pinion connected to a steering wheel and a rack. The first driven pinion has a toothed outer-surface. The second drive pinion has a generally barrel-shaped toothed outer-surface extending axially along a portion of the second drive pinion. The rack has a toothed outer-surface. The teeth of the first driven pinion mesh with the teeth of the rack at a first location and the teeth of the second drive pinion mesh with the teeth of the rack at a second location.

In yet another aspect this invention provides a method for engaging a pinion with a rack. The method comprises initially providing a first pinion having a generally barrel-shaped toothed outer-surface having first and second ends and a middle section. A diameter of the middle section is larger than a diameter of the first end and larger than a diameter of the second end. Next a rack is provided having a toothed outer-surface. Finally the toothed generally barrel-shaped outer-surface of the first pinion is meshed with the toothed outer-surface of the rack at a first location.

The present invention together with further objects and advantages will be best understood by reference to the following detailed description taken in conjunction with the accompanying drawings.

### BRIEF DESCRIPTION OF SEVERAL VIEWS OF THE DRAWINGS

FIG. 1 is a front view of the prior art for a single cylindrical pinion;

FIG. 2 is a perspective view of the prior art for a dual cylindrical pinion-rack system wherein the dual-pinions are aligned parallel to one another on a circumference of the rack at an installation angle of 0° measured from P-P which is perpendicular to the rack;

FIG. 2A is a front view of the pinion 34 shown in FIG. 2;

FIG. 2B is a front view of the pinion 30 shown in FIG. 2;

FIG. 3 is a perspective view of the prior art for a dual cylindrical pinion-rack system wherein the dual-pinions are aligned at an angle to each other on a circumference of the rack;

FIG. 3A is a front view of the pinion 86 shown in FIG. 3;

FIG. 3B is a front view of the pinion 82 shown in FIG. 3;

FIG. 4 is a perspective view of the prior art for a cylindrical pinion aligned at an angle to a rack;

FIG. 4A is a sectional view along F-F in FIG. 4;

FIG. 4B is a close-up view of the section shown in circle V in FIG. 4A;

FIG. 4C is a sectional view along G-G in FIG. 4;

FIG. 4D is a close-up view of the section shown in circle T in FIG. 4C;

FIG. 5 is a front view of an embodiment of the present invention for a single barrel-shaped pinion;

FIG. 6 is a perspective view of an embodiment of the present invention for a dual barrel-shaped pinion-rack system wherein the dual-pinions are aligned parallel to one another;

FIG. 6A is a front view of the pinion 190 shown in FIG. 6;

FIG. 6B is a front view of the pinion 194 shown in FIG. 6;

FIG. 7 is a perspective view of an embodiment of the present invention for a dual barrel-shaped pinion-rack system wherein the dual-pinions are aligned at an angle to each other;

FIG. 7A is a front view of the pinion 246 shown in FIG. 7;

FIG. 7B is a front view of the pinion 242 shown in FIG. 7;

FIG. 8 is a perspective view of an embodiment of the present invention for a barrel-shaped pinion aligned at an angle to a rack;

FIG. 8A is a sectional view along J-J in FIG. 8 when the rack is at a first position turned zero degrees around its centerline;

FIG. 8B is a close-up view of the section shown in circle R in FIG. 8A;

FIG. 8C is a sectional view along K-K in FIG. 8 when the rack is at a second position turned one degree around its centerline;

FIG. 8D is a close-up view of the section shown in circle S in FIG. 8C;

FIG. 9 is a perspective view of a D-Shaped Rack Design utilizing an embodiment of the present invention;

FIG. 10 is a perspective view of a Y-Shaped Rack Design utilizing an embodiment of the present invention;

FIG. 10A is another perspective view of the embodiment shown by FIG. 10;

FIG. 11 is a flow diagram illustrating one exemplary method in accordance with the present invention.

### DETAILED DESCRIPTION OF THE INVENTION

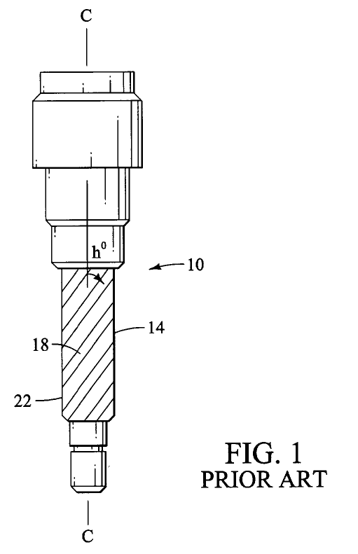

Referring to the drawings, FIGS. 1-4 show various forms of the prior art utilizing cylindrical pinion-rack systems. As shown in FIG. 1, a cylindrical pinion 10 includes a generally cylindrically-shaped outer surface 14 extending axially along the pinion 10. The outer surface 14 has teeth 18 extending in a helical shape around its circumference 22. The helix angle h may range from 0° to 45° as measured from the centerline C-C of the pinion 10.

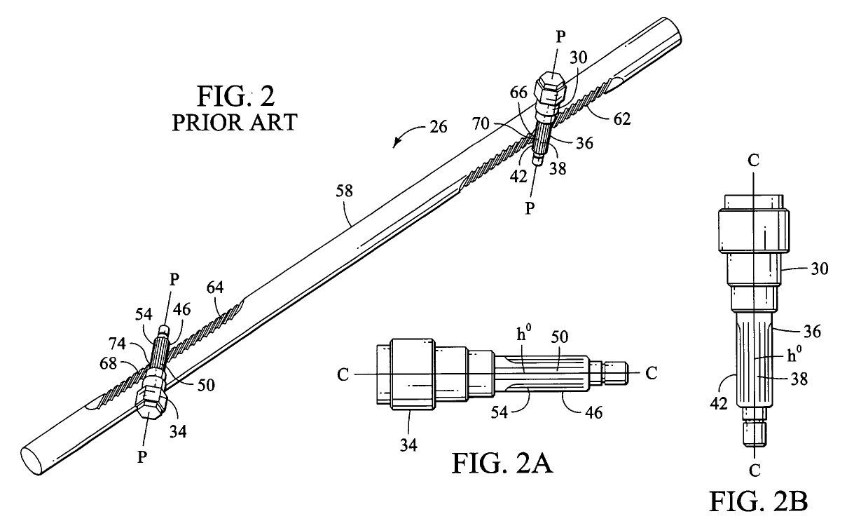

FIGS. 2, 2A and 2B show a dual cylindrical pinion-rack system 26 having a first cylindrical drive pinion 30 connected to a steering wheel (not shown) and a second cylindrical driven pinion 34 driven by an electrical motor (not shown). The dual-pinions 30 and 34 are aligned parallel to one another on a circumference of a rack 58 at an installation angle of 0° measured from P-P which is perpendicular to the rack 58. The first cylindrical drive pinion 30 includes a generally cylindrically-shaped outer surface 36 extending axially along the drive pinion 30. The outer surface 36 has teeth 38 extending around its circumference 42. The teeth 38 have a helix angle h which may range from 0° to 45° as measured from the centerline of the pinion 30. Similarly the second cylindrical driven pinion 34 includes a generally cylindrically-shaped outer surface 46 extending axially along the driven pinion 34. The outer surface 46 has teeth 50 extending around its circumference 54. The teeth 50 have a helix angle h which may range from 0° to 45° as measured from the centerline of the pinion 34. An elongated rack 58 has first and second outer surfaces 62 and 64 extending axially along the rack 58. The first and second outer surfaces 62 and 64 of the rack 58 each have teeth 66 and 68 extending axially along the rack 58. The teeth 66 and 68 of the first and second outer surfaces 62 and 64 in this embodiment may have different teeth-to-rack circumference ratios. The teeth 38 of the first cylindrical drive pinion 30 mesh with the teeth 66 of the first outer surface 62 of the rack 58 at a first location 70. The teeth 50 of the second cylindrical driven pinion 34 mesh with the teeth 68 of the second outer surface 64 of the rack 58 at a second location 74.

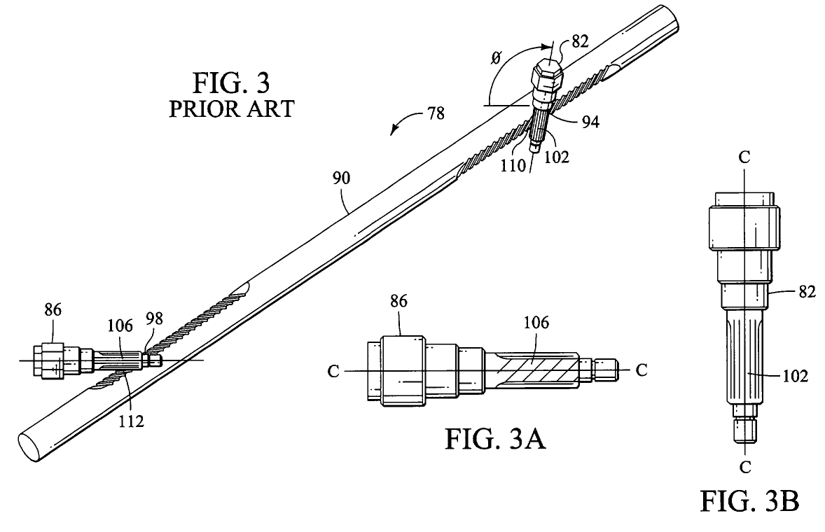

FIGS. 3, 3A and 3B are identical to FIGS. 2, 2A and 2B with the exception that they show a dual cylindrical pinion-rack system 78 having a first cylindrical drive pinion 82 angled at degrees with respect to a second cylindrical driven pinion 86 on the circumference of a rack 90. The angle of degrees requires an even tighter tolerance than required in FIG. 2 at the first and second locations 94 and 98 where the teeth 102 of the first cylindrical drive pinion 82 and the teeth 106 of the second cylindrical driven pinion 86 engage the teeth 110 and 112 of the rack 90. The teeth 110 and 112 at the first and second locations 94 and 98 must be machined in two steps. The angle tolerance at these first and second locations 94 and 98 must be extremely tight to avoid a negative effect in steering performance. Further, the tolerance range is made even tighter from additional tolerance limitations due to the installation of the housing towers (not shown) which hold the pinions 82 and 86. These tolerance requirements necessitate complex and expensive machining during manufacture of the rack 90.

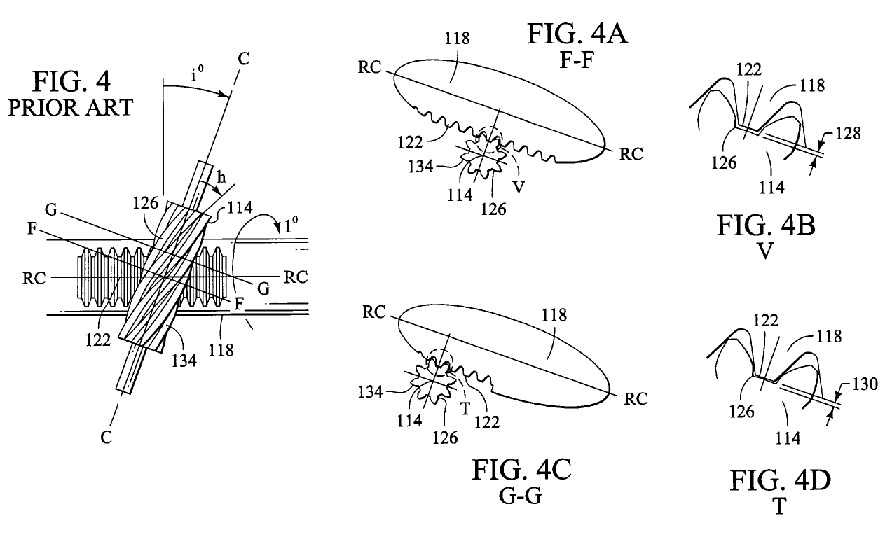

FIG. 4 shows a cylindrical pinion 114 aligned at an installation angle i on the circumference of a rack 118. The pinion 114 has teeth 126 having a helix angle h ranging from 0° to 45° from the pinion's centerline C-C. FIG. 4A shows a sectional view F-F of the meshing of the teeth 122 of the rack 118 with the teeth 126 of the pinion 114 when the rack 118 is at a first position turned zero degrees (0°) around its centerline RC. FIG. 4B shows the clearance 128 between the teeth 122 of the rack 118 and the teeth 126 of the pinion 114 at the first position shown by circle V in Sectional view F-F. FIG. 4C shows a sectional view G-G of the meshing of the teeth 122 of the rack 118 with the teeth 126 of the pinion 114 when the rack 118 is rotated one degree (1°) around its centerline RC. FIG. 4D shows the clearance 130 between the teeth 122 of the rack 118 and the teeth 126 of the pinion 114 at the Sectional view G-G shown by circle T when the rack is rotated one degree (1°) around its centerline RC.

In order to determine the tolerance of the angle between dual-pinions around the circumference of a rack, the tolerances of each pinion tower's housing and the tolerances of the teeth of the rack at each meshing location must be approximated and combined. To simulate the sum of these tolerances, the clearance between the teeth of the rack and the teeth of the pinion when the rack is rotated one degree (1°) around its centerline has been determined. The rotation of the rack around its centerline RC simulates the machining tolerances of the toothed locations on the circumference of the rack. The testing has shown that the clearance 128 between the teeth 122 of the rack 118 and the teeth 126 of the pinion 114 at the first position, when the rack has been turned zero degrees (0°) around its centerline C, is typically two to three times larger than the clearance 130 between the teeth 122 of the rack 118 and the teeth 126 of the pinion 114 when the rack is rotated one degree (1°) around its centerline C.

The decrease in clearance as the rack 118 rotates around its centerline C is caused by the teeth 122 of the rack 118 moving closer to the teeth 126 of the pinion 114 due to the cylindrical shape of the pinion's outer surface 134 and the uneven alignment of the teeth 122 of the rack 118 with the centerline of the pinion 114. This occurs because the pinion's outer surface 134 is cylindrically-shaped keeping the teeth 126 of the pinion 114 at a constant position despite the teeth 122 of the rack 118 being forced to move closer to the teeth 126 of the pinion 114 due to the rotation of the rack 118 and the uneven alignment.

On a rack with two tooth system areas engaged with dual-pinions the decrease in clearance upon rotation of the rack requires the manufacturing processes to be very accurate to keep the tolerances within the range required. Further effecting the tolerance range is an effect referred to as “rack roll” which is caused by the meshing of a helical shaped pinion with a rack. During “rack roll”, the rack turns slightly along its centerline during the rack's axial movement due to a lack of restraint of the rack. This occurs due to machining tolerances and heat treatment distortion resulting in differing pressure angles, differing helix angles and differing diameters of the rack and pinions. It may occur in single and dual-pinion electric systems, electric hydraulic systems, hydraulic systems and in manual steering gears. Furthermore, in a dual-pinion system the tolerance range is altered by potential variance in the desired location of the teeth of the rack at both the first and second locations due to machining tolerances such as the accuracy of the clamping during manufacturing of the rack. As a result, time-consuming, complicated and expensive manufacturing processes are required.

The present invention discloses a generally barrel-shaped pinion to alleviate the clearance problem caused by the cylindrically-shaped pinions of the prior art. A generally barrel-shaped pinion is defined as a pinion which has a generally arcuate axially extending outer surface. To further define a generally barrel-shaped pinion, the diameter of the generally barrel-shaped pinion in between the pinion's two ends is greater than the diameter at either pinion end.

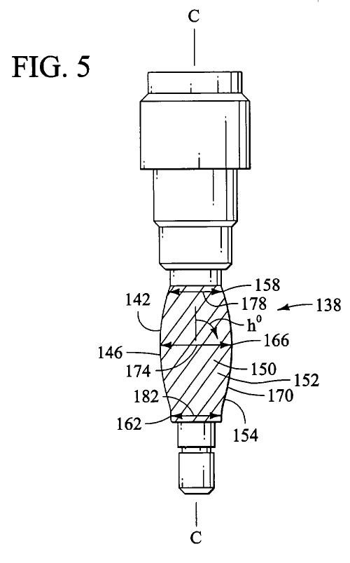

FIG. 5 shows a generally barrel-shaped pinion 138. The barrel-shaped pinion 138 includes a generally barrel-shaped outer surface 142 extending axially along a portion 146 of the pinion 138. The outer surface 142 has generally barrel-shaped teeth 150 corresponding to or complimenting the shape of the outer surface 142 and extending in a generally helical shape around its circumference 154. The helix angle h of the teeth 150 may range from 0° to 45° measured from the pinion's centerline C-C. The teeth 150 and the outer surface 142 define grooves 152 running between each set of teeth 150. The outer surface 142 has a first end 158, a second end 162 and a middle section 166. A diameter 174 of the middle section 166 is larger than both a diameter 178 of the first end 158 and a diameter 182 of the second end 162. A cross-section 170 of the outer surface 142 may generally resemble the shape of a rounded barrel in that the cross section 170 is largest at the middle section 166 and continuously decreases towards both the first end 158 and second end 162. In some embodiments both the diameter 178 of the first end 158 and the diameter 182 of the second end 162 may be identical. In other embodiments the diameter 178 may differ from the diameter 182.

The generally barrel-shaped pinion 138 is preferably manufactured of steel using any one of a number of different processes such as a 3D-hobbing process, a forming process or a grinding process.

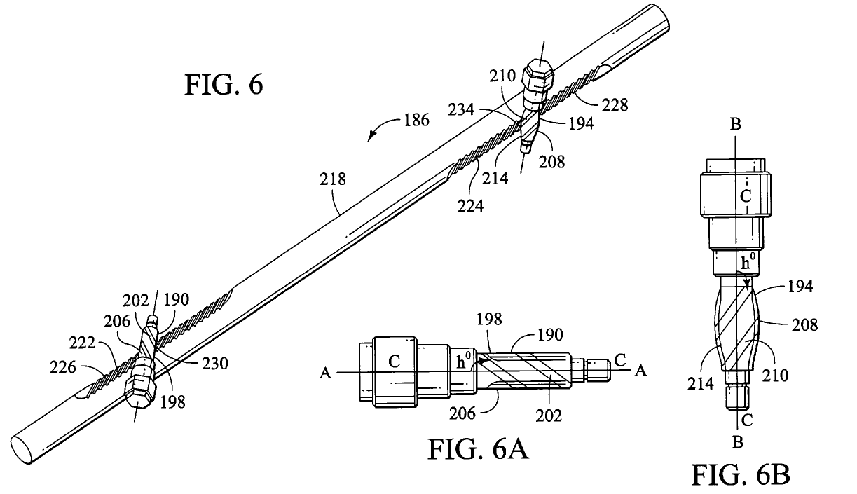

FIGS. 6, 6A and 6B show a dual-pinion rack gear system 186 incorporating a generally barrel-shaped pinion 194. The dual-pinion rack gear system 186 has a first generally cylindrical driven pinion 190 driven by an electrical motor (not shown) and a second generally barrel-shaped drive pinion 194 connected to a steering wheel (not shown). In this embodiment the first generally cylindrical driven pinion 190 and the second generally barrel-shaped drive pinion 194 are arranged parallel to each other along the rack 218. In other embodiments the first generally cylindrical driven pinion 190 and the second generally barrel-shaped drive pinion 194 may be oriented at an angle to each other along the rack 218.

The first generally cylindrical pinion 190 includes a generally cylindrically-shaped outer surface 198 extending axially along the driven pinion 190. The outer surface 198 has teeth 202 extending in a helical shape around its circumference 206. The second generally barrel-shaped drive pinion 194 includes a generally barrel-shaped outer surface 208 extending axially along the drive pinion 194. Teeth 210 extend across the outer surface 208 in a generally helical shape around the pinion's circumference 214. For both the teeth 202 of the first generally cylindrical pinion 190 and the teeth 210 of the second generally barrel-shaped drive pinion 194, the helix angle h measured from each pinion's centerline C-C may range from 0° to 45°. The elongated rack 218 contains first and second outer surfaces 222 and 224 extending radially and axially across the rack 218. Teeth 226 and 228 extend axially along the first and second outer surfaces 222 and 224 of the rack 218. The teeth 226 and 228 may be perpendicular to the centerline of the rack or at varying helix angles measured from the centerline, and may have differing tooth to rack circumference ratios. The teeth 202 of the first cylindrical driven pinion 190 mesh with the teeth 226 of the rack 218 at a first location 230. At a second location 234 the teeth 210 of the second generally barrel-shaped drive pinion 194 mesh with the teeth 228 of the rack 218.

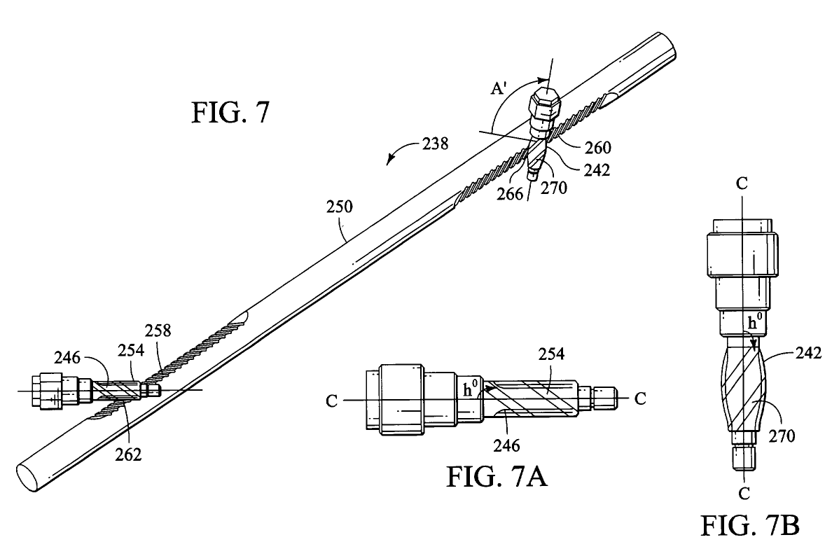

FIGS. 7, 7A and 7B show a dual-pinion rack gear system 238 incorporating a generally barrel-shaped pinion 242 aligned at an angle À to a cylindrical driven pinion 246 with respect to the circumference of a rack 250. The angle À may vary. The pinions 242 and 246 may be aligned in varying angles with respect to each other and may be aligned in similar or opposite directions. Further the pinions 242 and 246 may be aligned at any locations along the circumference of the rack 250. The teeth 254 of the first cylindrical driven pinion 246 mesh with teeth 258 of the rack 250 at a first location 262. Likewise at a second location 266 the teeth 270 of the second generally barrel-shaped drive pinion 242 mesh with teeth 260 of the rack 250. The teeth 254 and 270 of the pinions 246 and 242 extend in a generally helical shape across the circumference of the pinions and may have varying helix angles h ranging from zero (0°) to forty-five (45°) degrees measured from the pinions' centerlines. The teeth 258 of the rack 250 at the first location 262 may be angled with respect to the teeth 260 of the rack at the second location 266 and may have varying tooth to pinion circumference ratios. Further, the first and second locations 262 and 266 may be offset radially and/or axially.

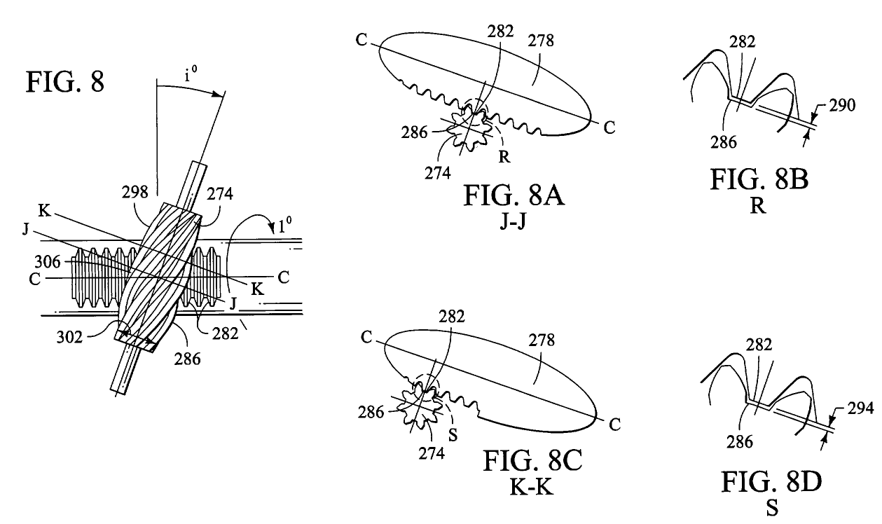

For clearance comparison purposes between the cylindrical pinions of the prior art and the generally barrel-shaped pinion of the instant invention, FIG. 8 shows a generally barrel-shaped pinion 274 aligned at an installation angle i to a rack 278. FIG. 8A shows a sectional view J-J of the meshing of the teeth 282 of the rack 278 with the teeth 286 of the pinion 274 when the rack 278 is at a first position turned zero degrees (0°) around its centerline C. FIG. 8B shows the clearance 290 between the teeth 282 of the rack 278 and the teeth 286 of the pinion 274 at the first position shown by circle R in Sectional view J-J. FIG. 8C shows a sectional view K-K of the meshing of the teeth 282 of the rack 278 with the teeth 286 of the pinion 274 when the rack 278 is rotated one degree (1°) around its centerline C. FIG. 8D shows the clearance 294 between the teeth 282 of the rack 278 and the teeth 286 of the pinion 274 at the Sectional view K-K shown by circle S when the rack is rotated one degree (1°) around its centerline C.

The clearance results for the generally barrel-shaped pinion are much improved over the previously discussed clearance results for the generally cylindrically-shaped pinions of the prior art. For example in some embodiments testing has established that the clearance 290 between the teeth 282 of the rack 278 and the teeth 286 of the pinion 274 at the first position, when the rack has been turned zero degrees (0°) around its centerline C, is generally identical to the clearance 294 between the teeth 282 of the rack 278 and the teeth 286 of the pinion 274 when the rack 278 is rotated one degree (1°) around its centerline C. This is due to the pinion's outer surface 298 being generally barrel-shaped reducing the cross section 302 of the pinion 274 as it gets further away from the middle section 306, while conversely the teeth 282 of the rack 278 are forced to move closer to the teeth 286 of the pinion 274 as the rack 278 rotates.

The improved clearance results avoid the necessity of high expense manufacturing processes during formation of the rack by reducing the tolerance level required during manufacturing. Small radial angle differences in the teeth of the pinion and rack are thus accommodated for by the generally barrel-shaped pinion. These radial angle differences may occur due to small radial misalignments between the pinion and the rack, slight radial movements of the rack around its centerline because of meshing interference with the pinion, or incorrect machining of the pinion and/or rack. Further, the improved clearance results accommodate for rack roll effects and variance in the desired locations of teeth on the rack at both first and second locations due to machining tolerances.

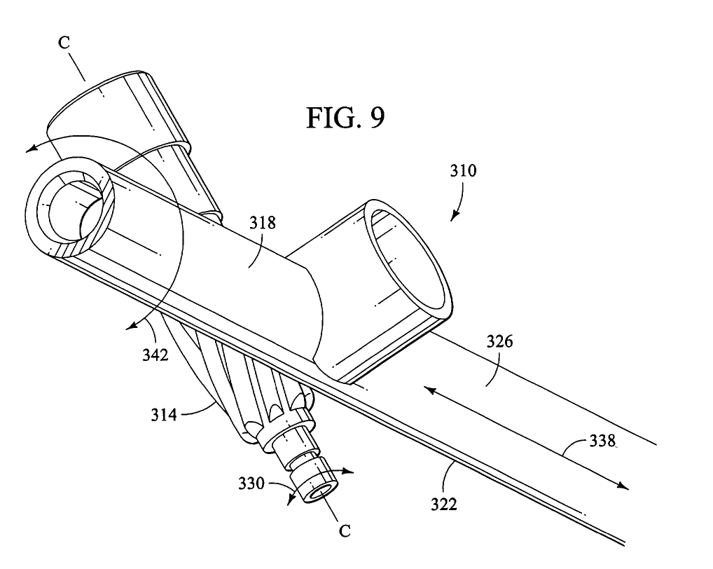

FIG. 9 shows a D-shaped rack design 310 utilizing a barrel-shaped pinion 314 across a circumference of the D-shaped rack 318. The rack 318 is referred to as being D-shaped because it has a first generally elongated outer surface 322 and a second generally cylindrical outer surface 326 forming a D. As the pinion 314 rotates 330 with respect to its centerline C-C the rack 318 moves axially 338 causing the rack 318 to experience a rack roll effect 342. However, use of the barrel-shaped pinion 314 accommodates for the rack roll effect 342.

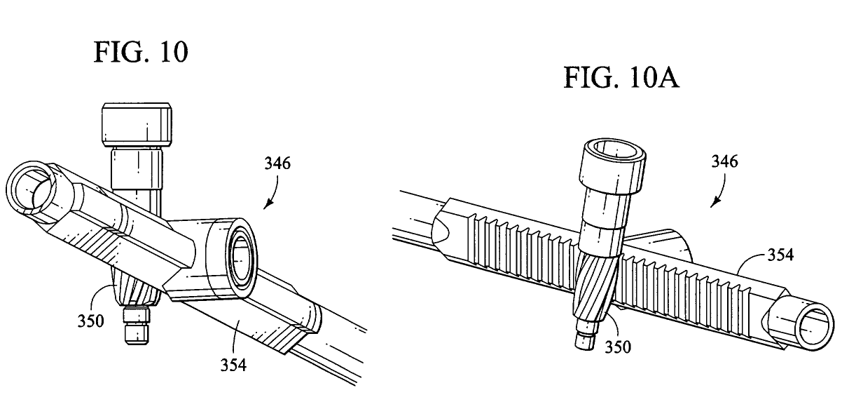

FIGS. 10 and 10A show a Y-shaped rack design 346 utilizing a barrel-shaped pinion 350 across a circumference of the Y-shaped rack 354. The rack design 346 is referred to as being Y-shaped because it is in the shape of a Y and slides axially in a Y-shaped yoke housing. The Y-shaped yoke housing prevents the Y-shaped rack 354 from experiencing the rack roll effect by restraining the rack 354 from rotating around its centerline. The barrel-shaped pinion 350 is useful in preventing high pinion torques, bad return, and prevents the necessity for heightened steering efforts because potential inequalities in the gear set are compensated by the barrel-shaped pinion 350.

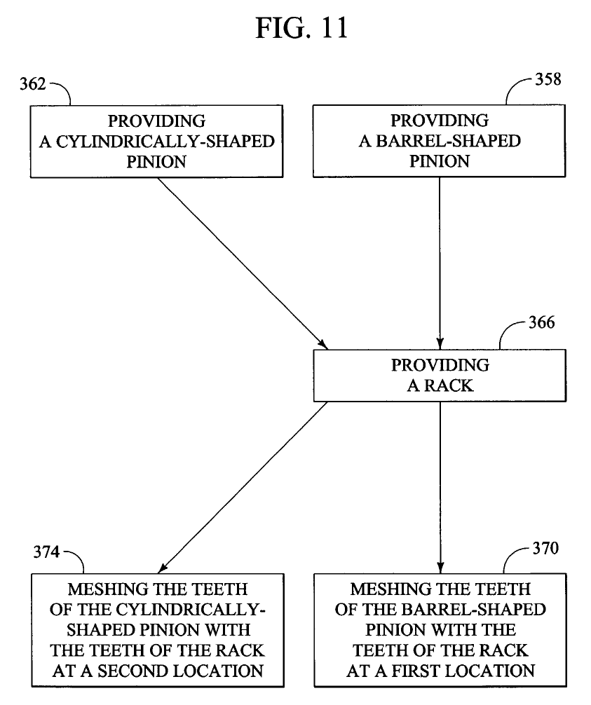

As shown in FIG. 11 one method for engaging a pinion with a rack is to first provide a generally barrel-shaped pinion 358. The pinion preferably comprises a toothed outer-surface having first and second ends and a middle section. A diameter of the middle section is preferably larger than a diameter of the first end and a diameter of the second end. A second pinion having a generally cylindrically-shaped toothed outer surface may be provided 362. Next a rack is provided 366. The rack preferably has a toothed outer-surface. Finally the teeth of the generally barrel-shaped outer-surface of the pinion are meshed with the teeth of the outer-surface of the rack at a first location 370. The teeth of the generally cylindrically-shaped outer surface of the second pinion may also be meshed with the teeth of the outer-surface of the rack at a second location 374. The generally barrel-shaped pinion may be aligned parallel to the second pinion along the circumference of the rack, or may be aligned at varying angles in any direction with respect to the second pinion along the circumference of the rack.

It is to be understood that the invention is not to be limited to the exact construction and/or method which has been illustrated and discussed above, but that various changes and/or modifications may be made without departing from the spirit and the scope of the invention.

What is claimed is:

1. A pinion comprising:
a generally barrel-shaped toothed outer-surface extending axially along a portion of the pinion, said toothed outer surface having first and second ends and a middle section, wherein a diameter of said middle section is larger than a diameter of said first end, and said diameter of said middle section is larger than a diameter of said second end.

2. The invention of claim 1 wherein the teeth of said outer-surface extend axially along a portion of the pinion in a generally helical shape.

3. The invention of claim 2 wherein said generally helical shape has a helix angle ranging from 0 degrees to 45 degrees.

4. The invention of claim 1 wherein the generally barrel-shaped toothed outer-surface is manufactured by one of a 3D-hobbing process, a forming process and a grinding process.

5. The invention of claim 1 wherein the diameters of said first and second ends are identical.

6. The invention of claim 1 wherein the diameters of said first and second ends are different.

7. A dual-pinion rack gear system comprising:
a first driven pinion driven by an electrical motor, said first driven pinion having a toothed outer-surface;
a second drive pinion connected to a steering wheel, wherein said second drive pinion has a generally barrel-shaped toothed outer-surface extending axially along a portion of the second drive pinion; and
a rack having a toothed outer-surface, wherein the teeth of said first driven pinion mesh with the teeth of said rack at a first location, and the teeth of said second drive pinion mesh with the teeth of said rack at a second location.

8. The invention of claim 7 wherein said first driven pinion and said second drive pinion are aligned parallel to each other along a circumference of the rack.

9. The invention of claim 7 wherein said first driven pinion and said second drive pinion are aligned at an angle to each other along a circumference of the rack.

10. The invention of claim 7 wherein the toothed outer-surface of said first driven pinion is generally cylindrical.

11. The invention of claim 7 wherein the toothed outer-surface of said second drive pinion has first and second ends and a middle section, wherein a diameter of said middle section is larger than a diameter of said first end, and said diameter of said middle section is larger than a diameter of said second end.

12. The invention of claim 11 wherein the diameters of said first and second ends are identical.

13. The invention of claim 11 wherein the diameters of said first and second ends are different.

14. The invention of claim 7 wherein the teeth of said first driven pinion extend axially along a portion of the first driven pinion in a generally helical shape, and the teeth of said second drive pinion extend axially along a portion of the second drive pinion in a generally helical shape.

15. The invention of claim 14 wherein said generally helical shapes of said teeth of said first driven pinion and said second drive pinion both have a helix angle ranging from 0 degrees to 45 degrees.

16. The invention of claim 7 wherein said first location is aligned at an angle to said second location.

17. The invention of claim 7 wherein the teeth of said rack at said first location are angled with respect to the teeth of said rack at said second location.

18. A method for engaging a pinion with a rack comprising:
providing a first pinion having a generally barrel-shaped toothed outer-surface having first and second ends and a middle section, wherein a diameter of said middle section is larger than a diameter of said first end, and said diameter of said middle section is larger than a diameter of said second end;
providing a rack having a toothed outer-surface; and
meshing the toothed generally barrel-shaped outer-surface of said first pinion with the toothed outer-surface of said rack at a first location.

19. The invention of claim 18 further comprising providing a second pinion having a generally cylindrically-shaped toothed outer surface, and meshing the generally cylindrically-shaped toothed outer surface of said second pinion with the toothed outer-surface of said rack at a second location.

20. The invention of claim 19 wherein said first pinion and said second pinion are aligned parallel to each other along the rack.

21. The invention of claim 19 wherein said first pinion and said second pinion are aligned at an angle to each other along a circumference of the rack.
